(19) United States
(12) Patent Application Publication
(10) Pub. No.: US 2018/0017420 A1
(43) Pub. Date: Jan. 18, 2018

(54) METHOD AND APPARATUS FOR ANALYZING A MATERIAL FLOW

(71) Applicant: Rheinisch-Westfaelische Technische Hochschule (RWTH) Aachen, Aachen (DE)

(72) Inventors: Hermann WOTRUBA, Aachen (DE); Kilian NEUBERT, Aachen (DE); Tobias VRAETZ, Waldfeucht (DE); Franz Domenic BOOS, Aachen (DE); Karl NIENHAUS, Hauset (Raeren) (BE); Ralph BALTES, Simmerath (DE); Henning KNAPP, Aachen (DE)

(21) Appl. No.: 15/548,253

(22) PCT Filed: Nov. 25, 2015
(86) PCT No.: PCT/DE2015/100504

§ 371 Date: Aug. 2, 2017

(30) Foreign Application Priority Data
Feb. 3, 2015 (DE) 10 2015 101 537.4

(51) Int. Cl. G01F 1/66; G01N 29/04; G01N 29/14; G01N 29/44

(52) U.S. Cl. CPC G01F 1/666; G01N 29/4427; G01N 29/4436; G01N 29/046; G01N 29/14; G01N 2291/024

(57) ABSTRACT

A method and an arrangement for analysis of a material flow (S) is disclosed having one or more material components. The material flow (S) is conducted via a conveyor line. One or more acoustic sensors are allocated to the conveyor line. Acoustic signals produced by the material flow (S) are detected by the acoustic sensors and then converted into digital signals. The digital signals are analyzed in an evaluating unit in a computer-assisted manner and analyzed by means of an algorithm in comparison to reference values specified based on individual identifying characteristics of the material components, such that the material components are identified and the mass fraction of at least one material component in the material flow (S) is determined.

### CROSS REFERENCE TO RELATED APPLICATIONS

The present application is a National Phase of International Application Number PCT/DE2015/100504 filed Nov. 25, 2015 and related to and claims priority benefits from German Application Number 10 2015 101 537.4 filed Feb. 3, 2015.

### BACKGROUND

### 1. Field of the Invention

The disclosure is related to a method for analyzing a material flow as well as a configuration for conducting the method. More specifically, the disclosure is related to a material flow of one or a plurality of solids, in particular primary and/or secondary mineral raw materials, including metals. A material flow can also consist of, or contain, plastics. Furthermore, a material flow may consist of waste products, in particular industrial waste products such as slag, ashes and other residues from industrial operations.

### 2. Description of the Related Art

Global economic growth, especially in industrial and emerging markets, is leading to a steady increase in raw material requirements. A large proportion of the required raw materials is currently being made available from primary non-renewable mineral deposits. The challenge of primary raw material management is to meet the rising demand for raw materials, despite declining levels of reusable material and increasingly complicated storage conditions. At the same time, it is essential that existing raw material deposits are used as efficiently as possible from a sustainability perspective. These circumstances point to the necessity for the development and use of new innovative processing technologies for efficiently exploiting existing raw material resources.

Very few minerals have sufficient purity, directly after mining, which would allow them to be used immediately in subsequent processes. In general, mineral raw materials must therefore undergo physical processing after they are successfully mined. Depending on the type of raw material extracted, various methods may come into play for the processing of the raw materials or minerals. After the extraction and transport of the raw materials to the processing plant, the minerals pass through various stages of physical processing in accordance with the requirements applicable to the final product in terms of purity and concentration. These include, among others, crushing, classifying and sorting the minerals. A detailed knowledge of the composition and properties of reactants and products of individual process stages in a processing plant is therefore important, to be able to conduct processing operations as efficiently as possible. The statement on the value and density distribution in the reactant and product flows is particularly important for evaluating, controlling, and regulating the treatment processes.

In the processing of mineral raw materials, it is therefore important to have the best possible knowledge of the properties and chemical composition of the raw materials being treated, to ensure efficient processing. As a rule, it involves a material flow that consists of one or a plurality of components, and which consists of one or a plurality of valuable minerals, which under the circumstances may still need to be unlocked from a grain as well as one or a plurality of accompanying components, in particular accompanying minerals. Should the material flow or material composition and the mass distribution of a multicomponent material flow be known, the following processes can then be better controlled.

There are currently both offline as well as online analyses for determining the density of a material flow. An online analysis has various advantages compared to a conventional offline analysis. At present, however, the average density of a material flow can only be determined online, for example by using a laser triangulation method and a belt scale. For some raw materials, it is also possible to derive an average density indirectly, for example by determining the ash content of coal. Only the density distribution provides a more precise statement regarding the raw material than does the average density, because only the density distribution, that is, the statement regarding a mass-based distribution of particles with different densities in the material flow, makes it possible to evaluate the degree of effectiveness of previous process steps, or to better adapt subsequent process steps by means of suitable automation technology.

The latest technology for determining the density distribution is the float/sink-analysis in a liquid medium. A sample is floated in a high-density liquid. Gradually, the density of the liquid is reduced, so that more particles or components of the substance start to sink. This analysis, however, often takes several hours and is therefore not suitable for a statement regarding the system's efficiency, and thus suitable for a short-term process control.

A major disadvantage of known analytical methods is that an analysis of the material flows is only possible offline. This is evident, for example, in the case of a material flow which consists of a mineral combination of gypsum and anhydride and which contains material components gypsum and anhydride in various mass distributions.

Because of its origin in many deposits, the mineral gypsum [CaSO₄*2H₂O] is often associated with the mineral anhydride [CaSO₄]. For the further processing steps, it is important not to exceed a defined limit value for anhydride, since this would otherwise lead to quality losses in subsequent product stages and its use. Currently, it is possible to determine the crystal water and thus the fraction of anhydride thermogravimetrically. However, this method lasts several minutes and is limited to individual samples. The delay in time, from the taking and analysing of the sample until the analysis results are obtained, may cause changes in its composition to only be recognized later. This time delay makes it impossible to control or regulate subsequent or upstream processes.

The above-mentioned problem also applies to other material flows, which contain various material components in various mass fractions, for example, material flows of coal and secondary rock.

### SUMMARY

According to one exemplary embodiment, a material flow is passed over a conveyor section. The conveyor section is provided with least one sound sensor, which captures acoustic signals generated by the material flow. The acoustic signals are converted into digital signals and sent to an evaluation unit. In the evaluation unit, a computer-assisted evaluation of the digits signals is carried out by means of an algorithm, in which the digital signals are compared with reference values, which are determined based on by means of individual recognition features of the material components. The evaluation unit will identify at least one material component and calculate its mass fraction in the material flow.

The evaluating unit has the corresponding means for identifying the material components as well as determining the mass fraction of one or more material components in the material flow. The arithmetic and logical operations required for this purpose are carried out in the evaluation unit in chronological and logical order. The results are displayed and/or provided as information via appropriate means, and, if necessary, directly or indirectly used for controlling the material flow or influencing the material flow.

The invention enables early detection and analysis of the material flow and its composition as well as the mass distribution of the individual material components in the material flow. This significantly improves the control of downstream processes. The monitoring of a material flow resulting from a sorting process also provides options for regulation. The direct and indirect costs thus saved lead to an increase in competitiveness.

As already mentioned in the introduction, in terms of the invention, a material flow is a material flow of one or a plurality of material components. These may be one or a plurality of solids, in particular from primary and/or secondary mineral raw materials, including metals. Such a material flow is formed, for example, in the mining of mineral raw materials such as gypsum and anhydride or also coal, as well as, for example, fluorspar and barite, iron ores, nonferrous metals or bauxite.

The material flow consists of at least two material components, with each of the material components representing a proportion of between 0% to 100% in the material flow. The process and configuration according to the invention are therefore also capable of identifying a material flow consisting only of a material component. In practice, however, the material flow consists predominantly of one or a plurality of material components which are contained in the material flow in varying mass distributions.

The material flow to be analyzed can also be a material flow branched off from a larger material flow.

The material flow is continuously passed over a conveyor section. The conveyor section is, in particular, part of a continuous conveyor or integrated into a continuous conveyor. The conveyor section can, for example, be a conveyor belt, a conveyor duct, a vibrating chute, a shaking chute, a pipeline or also a free-fall conveyor unit, or a component thereof.

The conveyor section is equipped with at least one sound sensor. This at least one sound sensor can be a sound emission sensor, a structure-borne sound sensor, an airborne sound sensor or a fluid-borne sound sensor.

One aspect of the invention provides for the allocation of a plurality of sound sensors, in particular sound sensors of different types, that is in particular a combination of a sound emission sensor and/or a structure-borne sound sensor and/or an airborne sound sensor and/or a fluid-borne sound sensor.

The sound sensor(s) detect(s) acoustic signals generated by the material flow. Acoustic signals are acoustic events in the form of sound waves which are generated during the movement of the material flow relative to the conveyor section.

Sound emission measurement or Acoustic Emission (AE) measurement involves a process which originated in non-destructive material testing. AE signals are generated when the metal structure is altered because of external loads. Possible cause of damage may include the initiation of cracks, crack growth, crack unification or friction. When such signals are generated, a small amount of energy is released in a short time. This impulse is in the pas range, so that a sampling in the megahertz range is required. Typical frequencies of an acoustic emission signal are in the range of greater than (>) 80 kHz to 2 MHz.

Structure-borne sound is, similar to Acoustic Emission, a form of sound that propagates in a solid. The frequency range of the classic structure-borne sound can be presented here from a few Hz (<0.1 Hz) to the high kHz range (approx. 20 kHz). Structure-borne sound analysis is traditionally used in condition monitoring of machines.

In addition to the structure-borne sound, airborne sound is also detected in the near vicinity. The information content of this signal is mostly the structure-borne signal, but the influence of different spatially separated signal sources can also be observed by means of airborne sound. For this purpose, it is provided in particular that the sound sensor(s) for example is/are arranged on a contact element of the conveyor section or on one of the contact elements integrated into the conveyor section. As it passes over the conveyor section, the material flow comes into contact with the contact element. The acoustic signals in the form of sound waves that are generated in this manner are detected by the sound sensor(s). Such a contact element can be, for example, a baffle plate or an element or a component of a continuous conveyor, such as a base plate, a chute or also a container or a container wall. In particular, the contact element is physically separated within the conveyor section. By means of airborne sound sensors, signals are detected which could not be detected with a single structure-borne sound sensor or sound emission sensor.

Depending on the material flow to be analyzed and the conveying medium as well as the design of the conveyor section, fluid-borne sound sensors can also be used.

The identification, i.e. the recognition of the individual material components, as well as the determination of the mass fraction of, for example, a or the relevant material component(s) in the material flow, takes place by means of individual identification features of the material components. These are stored in the system.

Where the term “system” is used hereinafter, this refers to the method according to the invention and the configuration according to the invention, including the associated components, both individually as well as collectively.

Individual identification features include, in particular, physical properties of the material components such as density, hardness or modulus of elasticity. Based on these identification features, individual characteristics, for example curved lines, are defined for the individual material components and stored in a database or in the evaluation unit. For this purpose, the process is adapted for individual use. The system is consequently coordinated and adjusted to the different material components to be expected in a material flow.

The disclosure enables a material-specific distinction to be made between material components of a material How, for example bulk materials such as gypsum and anhydride, as well a determination of the mass distribution. For example, a density distribution determination of coal and secondary rock as well as of ores in a material flow is possible. The detection of the density distribution of the raw materials in the coarse state alone makes it possible to collect data on the regulation and control of treatment processes.

A further benefit is being able to distinguish the material components in the material flow. Consequently, an identification of materials according to material types, such as gypsum and anhydride is possible, for example. Further applications may include, for example, the separation of industrial minerals such as halite and sylvanite. The use of the method and configuration according to the invention in the processing of iron ore is also promising. Here, the determination of the density distribution promises especially beneficial results.

The material detection and mass distribution are carried out via the evaluation of sound emission (AE), structure-home sound and/or airborne sound signals and/or liquid-borne sound signals. These are evaluated both in terms of time as well as frequency.

The measurement data acquisition of at least one of the sensors, preferably a plurality of sensors, takes place in a time-synchronous manner via a single evaluation unit. This ensures that the signals can be synchronized with each other. With the help of a control signal, the measuring system should be tested during the recording of the data for its functional integrity. The sensors can be connected individually, so that an assessment of the material flow can, for example, also be carried out based on structure-borne acoustic emission sensors only.

By combining different statistical parameters, one can then define reference values, which can be used to characterize the material flow and therefore the composition. Depending on the material to be characterized, the reference values can be developed both at a testing facility as well as during the ongoing processes within a plant. For the calculation of the reference values, the parameters of the one sensor, preferably of a plurality of sensors, are fused and the corresponding algorithm is stored for evaluation on the computing unit. The parameters are calculated block-by-block for block intervals that are defined according to material flow.

The algorithm used involves the calculation and evaluation of one or more of the following parameters:
Arithmetic mean
Median
Variance
Standard deviation
Effective value/RMS value (Root Mean Square
Quadratic mean/RMQ value
RMX value
Crest factor
Kurtosis factor
Maximum value
Peak2RMS value
Peak2Peak value.

One or more of the following parameters can be integrated into the evaluation for the calculation of specific reference values and thus for the characterization of material flows during the ongoing treatment process:

### Arithmetic Mean:

The arithmetic mean describes the statistical average value and is one of the location parameters in the statistics. For the arithmetic mean, add all values of a data set and divide the sum by the total number of values.

$$\overline{x} = \frac{1}{N} {\sum }_{i = 1}^{N} {x}_{i}$$

where:
x̅ arithmetic mean
N number of values
xᵢ i-th value mean

### Median:

The value that lies exactly in the middle of a data distribution is called median or a central value. One half of all individual data is always smaller, the other larger than the median. For an even number of individual data points, the median is one-half of the sum of the two values in the middle.

$$\tilde{x} = \{ \begin{matrix}x {+ 1}_{2} & for odd N \\ \frac{1}{2} ( {x}_{\frac{n}{2}} + {x}_{\frac{N}{2} + 1} ) & for even N\end{matrix}$$

where:
\tilde{x} Median
N number of values

### Variance:

The variance is a dispersion measure which characterizes the distribution of values around the arithmetic mean. It is the square of the standard deviation. The variance is calculated by dividing the sum of the squared deviations of all measured values from the arithmetic mean by the number of measured values.

$${S}^{2} = \frac{1}{N} {\sum }_{i = 1}^{N} {( {x}_{i} - \overline{x} )}^{2}$$

where:
S² variance
N number of values
xᵢ i-th value
x̅ arithmetic mean of all values

### Standard Deviation:

Standard deviation is a measure of the spread width of the values of a characteristic around its mean value (arithmetic mean). In simple terms, standard deviation is the average distance of all the measured projections of a characteristic from the average.

$$σ = \sqrt{\frac{1}{N} {\sum }_{i = 1}^{N} {( {x}_{i} - \overline{x} )}^{2}}$$

where:
σ standard deviation
N number of values
xᵢ i-th value
x̅ arithmetic mean of all values

### RMS Value:

$$RMS = \sqrt{\frac{1}{2} {\sum }_{i = 1}^{N} {x}_{i}^{2}}$$

where:
RMS effective value/quadratic mean
N number of values
xᵢ i-th value

### RMQ Value:

$$RMQ = \sqrt[4]{\frac{1}{N} {\sum }_{i = 1}^{N} {x}_{i}^{4}}$$

where:
RMQ RMQ value (quadratic mean)
N number of values
xᵢ i-th value

### RMX Value:

$$RMX = \sqrt[X]{\frac{1}{N} {\sum }_{i = 1}^{N} {x}_{i}^{X}}$$

where:
RMX RMX value
N number of values
xᵢ i-th value
X potency of the weight

### Crest Factor:

The crest factor describes the ratio of maximum amplitude to RMS value within a range.

$$C = \frac{{\vert x \vert}_{max}}{\sqrt{\frac{1}{N} {\sum }_{i = 1}^{N} {x}_{i}^{2}}}$$

where:
C Crest factor
N number of values
xᵢ i-th value

### Kurtosis Factor:

$$K = \frac{\frac{1}{N} {\sum }_{i = 1}^{N} {( {x}_{i} - \overline{x} )}^{4}}{{( \frac{1}{N} {\sum }_{i = 1}^{N} {( {x}_{i} - \overline{x} )}^{2} )}^{2}} - 3$$

where:
K Kurtosis factor
x̅ arithmetic mean
N number of values
xᵢ i-th value

In addition, the block-by-block determination of the following parameters is carried out for every interval range.

### Maximum Value:

The maximum value corresponds to the largest numerical element within the block interval:

MAX=max(x)

### Peak2 RMS Value:

The block-by-block Peak2RMS value is calculated from the ratio of the maximum value to the RMS value within a block interval.

$$P 2 R = \frac{max ( x )}{RMS ( x )}$$

### Peak2Peak Value:

The block-by-block Peak2Peak value is calculated from the difference between the maximum value and the minimum value within a block interval.

P2P=max(x)−min(x)

Alternatively, in the time range, characteristic bursts can also be extracted from the AE measurement data. A burst is a so-called transient AE signal. Here the beginning and the end stand out clearly from a possible background noise. These bursts have a characteristic signal shape, as shown by way of example in FIG. 5. The goal is the detection of such bursts and the evaluation of the AE signals of the described reference values (RMS, Peak2Peak, etc.). Derived reference values from the bursts (maximum amplitude, rise time, decay time, duration of a burst) can also be used to determine the material distribution. The algorithms developed for detecting the bursts recognize autonomous AE events in the time and frequency range and are characterized as follows:

### 1. Edge Detection:

The edge detection method makes use of characteristic features of the AE signals. For this purpose, the algorithm searches for regions of the AE signal with high gradients of the signal, which can be marked as the start of an AE event due to the short rise time of the AE bursts. The algorithm searches for areas within the AE signal in which the envelope curve has high gradients (rising edges). First, there is the calculation of the envelope curve of the AE signal, including a rectification as well as low-pass filtering of the raw signal. The envelope curve is then divided into partial sections and the partial calculation of the individual gradients is performed. If the derivative exceeds a limit value, the interval is recognized as part of a sharply rising part of the signal. Continuous regions with sharp rises are considered together as the beginning of a burst. As a last step, the algorithm determines the end of a burst above a defined threshold.

### 2. Shifting Windows:

The shifting windows algorithm uses a window to detect a burst. It is shifted over the entire data set. At each step, local maxima are detected. These are in turn used to describe the bursts. A burst occurs exactly at the point in time at which there is an extreme change in amplitude in the data set. The change in amplitude can therefore be indicated as a local extreme or a local maximum. The data to be checked can be limited by the window formation. The maximum value and its position can thus be found more quickly within the data set and marked as a potential burst. The window starts with viewing at the beginning of the data record and is shifted as a function of time on the corresponding axis with a defined step size. A window is in this case a fragment of the present data set, which is examined at a particular point in time. In order not to recognize and store regular, local maxima erroneously as bursts, the RMS values of neighbouring windows are compared with one another. This method completely does away with the definition of static reference values. First attempts with both conventional data loggers and AE based data loggers have already confirmed the robust and reliable functionality of the algorithm.

### 3. Frequency Detection:

In the frequency detection method, an AE measurement signal is analyzed in defined time intervals in the frequency range. The functioning of the AE sensors is based on the resonance principle. For this reason, it is evident that an increase in the frequency amplitudes always occurs exactly when a characteristic AE burst has taken place. From this effect, therefore, it is possible to detect a burst using the frequency range of a signal. Experiments with the measuring methods already mentioned have shown that dominant frequencies can be detected both at approx. 100 kHz as well as at approx. 300 kHz. The burst is then transferred to the time range

An essential aspect of the invention is that the algorithm for detecting and evaluating bursts is applied by means of edge detection, shifting window, and frequency detection. The individual bursts are subsequently evaluated. This evaluation of the bursts is performed on the basis of reference values, in particular on the basis of one or more of the following reference values: maximum amplitude, rise time, decay time, duration of a burst and parameters derived therefrom.

A number of significant benefits of the invention are summarized below:

The acoustic emission and structure-borne sound, as well as airborne sound or fluid-borne sound, can be used in various fields for the treatment of mineral raw materials. The technology can be used to perform subsequent processes more efficiently through accurate and fast analysis of the raw materials. A conclusion regarding the density distribution can be used to control or regulate existing processes in real time. As a result, products from a wide variety of treatment processes can be evaluated and the systems can be adapted, but the analysis of the input stream in a treatment process with subsequent control over the processes is also conceivable. The density sorting can be optimized by means of setting machines, which is one of the most frequently used processes in the field of mineral processing, and by means of which machine parameters can be adjusted to respond to fluctuating raw material characteristics. Here, the focus is on the density distribution of the bulk materials to be sorted, on the basis of which the machine can subsequently be controlled and regulated by means of suitable automation technology. Even small adjustments ensure the optimum quality of the manufactured products and additionally increase the yield of reusable material from the process. This reduces the loss of valuable, strategic raw materials and optimizes the utilization of existing deposit reserves. Efficient control and regulation of setting machines, based on a determination of the density distribution, is currently not possible and, given an increased raw material efficiency and improved utilization of existing raw material reserves, would make a decisive and valuable contribution.

In addition to the above-mentioned control and regulation of treatment processes, it is also possible to use these types of sensors for direct material flow sorting and mixing of material. Raw materials such as gypsum [CaS0₄·2H₂0] and anhydrite [CaSO₄] are currently difficult to differentiate from one another based on their chemical composition. Existing processes, such as thermogravimetry, can only be realized by means of laboratory technology and are very time-consuming, so that a timely analysis and adaptation of processes are not feasible. The method and configuration according to the invention enable a rapid analysis of a material flow from raw materials and provides the prerequisite for optimizing, in particular, the mixing ratios of entire material flows, even for certain types of raw materials which are difficult to distinguish. A precise statement regarding mixing ratios and the composition of material flows leads not only to more cost-effective treatment processes, also better utilization of existing raw material reserves.

The disclosure can be used in several ways. Firstly, it makes it possible to use sensory technology upfront for distinguishing only those types of raw material types that are difficult to distinguish from each other, thereby enabling an optimized process control. A possible application is the gypsum industry. There is a need to develop a technology for online analysis of gypsum and anhydrite, allowing for a more precise mixing of different types of raw materials. Adjusting to more accurate mixing ratios makes it possible to produce gypsum products with defined quality parameters more cheaply, as the more economical anhydrite can be added to the mixture, up to the desired limit value.

A further, promising area of application for the invention is the non-destructive and rapid characterization and evaluation of large volumes of material in a sorting process. There is large potential, especially in the optimization of density-sorting processes by means of a setting machine. A regulation and control system can be designed for setting machines, by combining the measurement data obtained from the sensor system with adapted automation algorithms. Compared to previously used process evaluations, which are time-intensive and not online, the invention enables rapid control and regulation, and thus the ability to adapt to altering material flow characteristics. The invention provides the prerequisites for clearly distinguishing material components occurring in a material flow from one another and determining their mass fraction. In particular, this allows one to determine an average density distribution adapted to the respective raw material, such measuring technology can be used for any material flow containing minerals or mineral aggregates that differ in terms of their density. In addition to the processing of iron ore and coal, the processing of the critical metals tungsten and tantalum is particularly important as a possible application area. Its integration into existing processes by measuring the task as well as the products of a process can be used to make adjustments to an ongoing process and thus to increase the yield of the valuable material.

### BRIEF DESCRIPTION OF THE DRAWINGS

For an understanding of embodiments of the disclosure, reference is now made to the following description taken in conjunction with the accompanying drawings, in which:

FIG. 1 is a schematic diagram for one exemplary embodiment of a testing station;

FIG. 2 is a sectional view through FIG. 1 along the line A-A with a schematic embodiment of the measuring point I;

FIG. 3 is an enlarged view from the embodiment in FIG. 1 in the region of a contact element integrated into the conveyor section, and the measuring point II provided there;

FIG. 4 is a circuit diagram showing al processing when using the method according to the exemplary embodiment; and,

FIG. 5 is an example of an acoustic emission signal, showing the amplitude over time.

In the Figures, the same reference designations are used for identical or similar components, even if a repeated description is omitted for reasons of simplicity.

### DETAILED DESCRIPTION OF SOME EMBODIMENTS

Some embodiments will be now described with reference to the Figures.

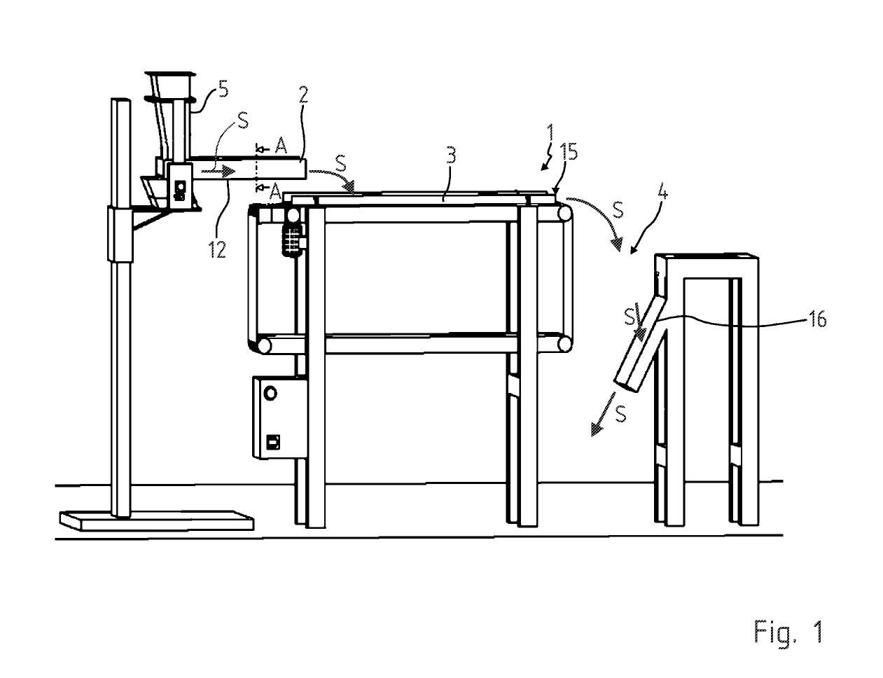

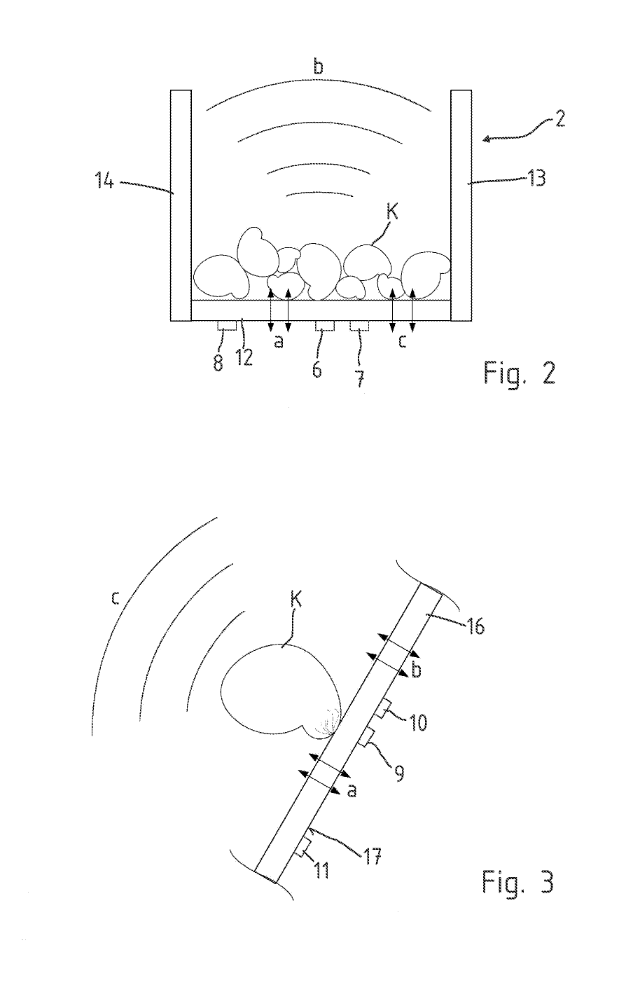

Referring to FIG. 1, a conveyor section 1, which in the test setup shown, comprises a vibration chute 2, a conveyor belt 3 and a free-fall section 4. A mixture of materials in the form of a material flow S, containing a plurality of material components, is fed via a feeding unit 5 to the conveyor section 1. Several sound sensors 6, 7, 8, 9, 10, 11 are allocated to the conveyor section 1 (see FIGS. 2 and 3).

In the arrangement shown here, a first measuring point I is provided in the region of the vibration chute 2. At the measuring point I, below the floor plate 12 of the vibrating chute 2, an acoustic emission sensor 6 as well as a structure-borne acoustic sensor 7 and an airborne sound sensor 8 are set up. The bottom plate 12 of the vibrating chute 2, as well as its side walls 13, 14, form a contact element with which the material components of the material flow S come into contact. The sound. sensors 6, 7, 8 are placed under the floor plate 12 and do not come into direct or immediate contact with the material flow S itself.

From the vibrating chute 2, the material flow S reaches the conveyor belt 3 and is discharged at the end 15 of the conveyor belt 3 and falls freely over the free-fall section 4. The material flow S then meets a contact in the form of a baffle plate 16, which is integrated into the conveyor section 1.

The baffle plate 16 is inclined against the vertical, so that the material flow S occurs at the baffle plate 12 at an angle. A second measuring point II is set up on the baffle plate 16. For this purpose, sound sensors 9, 10 and 11 are set up on the rear side 17 of the baffle plate 16. The sound sensors 9, 10, 11 are also sound emission sensors, structure-borne sound sensors and/or airborne sound sensors.

The material mixture is fed as a continuous material flow S over the conveyor section 1. During the movement of the material flow 5, the individual material components, that is, the grains K of the material flow S, come into contact with one another. In addition, the material flow S comes into contact with the components of the vibrating chute 2, in particular its bottom plate 12 as well as the baffle plate 16. Sound emissions are generated via these. These processes furthermore create airborne and structure-borne sound emissions. The analysis of the material flow S can take place at the measuring point I as well as at the measuring point II. There, acoustic signals are recorded in the form of sound emission, structure-borne noise and/or airborne sound.

The measuring point I evaluates the material flow S while the vibration chute 2 is running. The oscillation of the vibrating chute 2 generates a plurality of impulses, which are used to evaluate the acoustic emission signal (Acoustic Emission), as well as the structure-borne sound and the airborne sound. FIG. 2 shows the structure-borne sound emissions with the arrows a. The airborne sound waves are marked with the letter b. The structure-borne sound waves are indicated by c. The structure-borne sound signals make it possible to observe changes in the stiffness of the system (vibrational chute and material flow or material components). With the help of all three of these pieces of information, statements can then be made regarding the material flow composition.

The measuring point II is located behind the conveyor belt the end of the free-fall section 4 on the baffle plate 16. The sound sensors 9, 10, 11 are set up on the rear side 17 of the baffle plate 16. The material flow S comes up against the baffle plate 16. During this contact of the individual material components of the material flow 5, the three sound signals can in turn then be observed or detected, namely, sound emission, structure-borne sound and airborne sound. Upon impact with the impact plate 16, the impact impulse is substantially larger, which can lead to other evaluation algorithms. The vibration of the baffle plate 16 can be included as a further determining feature in the recognition and evaluation.

FIG. 3 shows an impact of the grain K of a material component of the material flow S onto the baffle plate 16. Upon impact, sound emissions are converted into the impact impulse from the destruction of the material and the impact. This is illustrated by the letter a. Airborne sound waves that are generated by the process, are indicated by b. Structure-borne sound vibrations of vibrating chute 2 and baffle plate 12, as a function of the stiffness, are indicated by the arrows c.

Although there are three sound sensors 6, 7, 8 at the measuring point I and three sound sensors 9, 10, 11 at the measuring point II in the sample setup described here, a sound sensor 6, 7, 8, 9, 10, 11 can be sufficient to detect the signals generated by the material flow S. The combination of a plurality of sound sensors 6-11 in the region of a measuring point is, however advantageous.

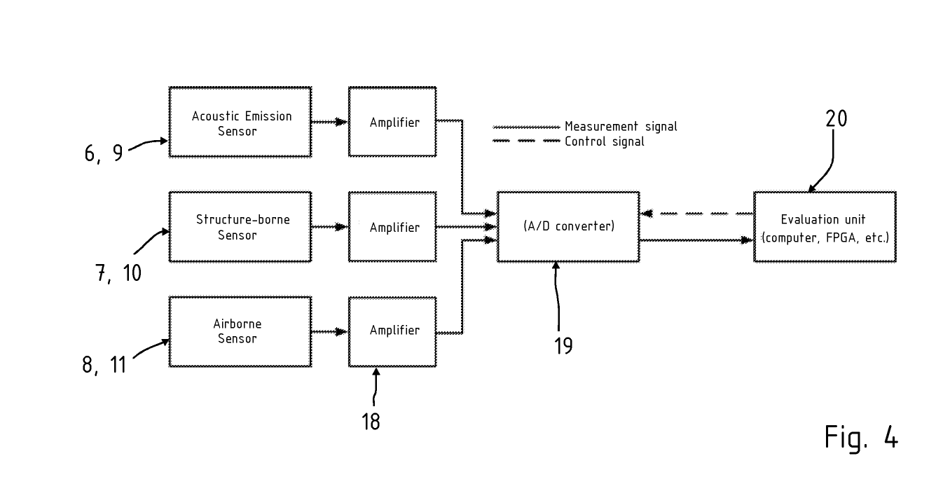

The acoustic signals generated by the continuous movement of the material flow S and recorded over the sound sensors 6-11 are amplified by means of an amplifier 18 (see FIG. 4) and converted into digital signals. An analog-to-digital converter 19, also called A/D converter, is provided for this purpose. An evaluation unit 20 connected to the system performs a computer-assisted evaluation of the digital signals by means of an algorithm. The results are compared to reference values determined based on individual identification characteristics of the material components. For this purpose, the system is programmed for a plurality of material components or, depending on the application or specific case, for the expected material components. The reference values are stored in a database which can be accessed by the evaluation unit 20, and which belongs to the system. The system can recognize patterns, repetitions, similarities and lases in the set van data and to compare these with the reference values stored in the system. This information is used to identify the material components as well as to determine the mass fraction of one or more material components of the material flow S. In terms of the practical tests, the density of the material components has been proven to be a particularly beneficial recognition characteristic.

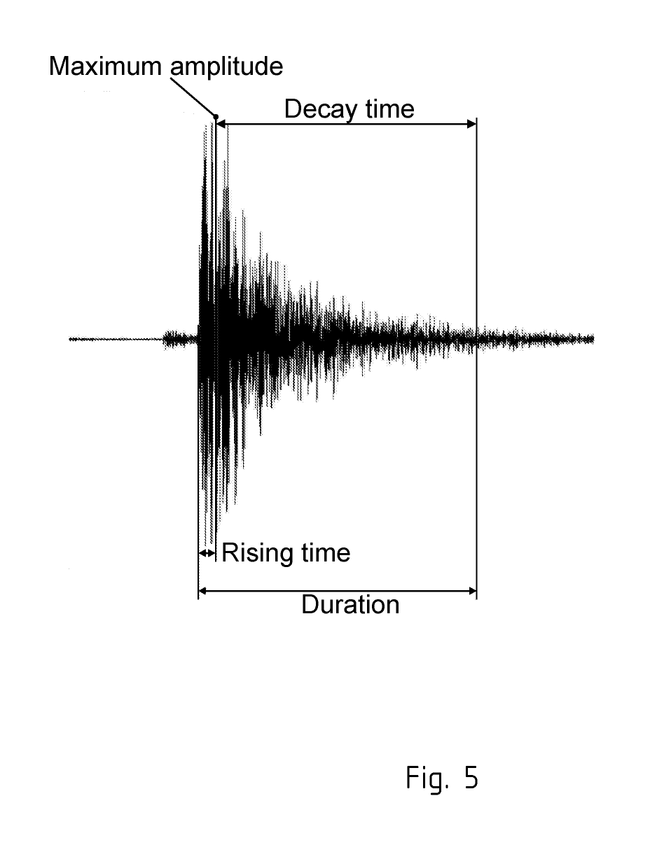

As already explained, FIG. 5 represents an AE signal over time, by showing changes in amplitude over time. The bursts have a characteristic signal form. The purpose of the evaluation of the AE signals is to compare the digital signals with reference values which are determined on the basis of individual recognition characteristics of the material components. This is done by means of algorithms. The algorithm or the algorithms include the evaluation and assessment of the parameters set forth in Claim 3 (RMS, Peak2Peak, Peak2RMS, etc.). Reference values derive from the bursts as well as maximum amplitude, rising time, decay time, duration of a burst) can also be used to determine the material distribution.

The system is based on the evaluation of several bursts, which result from the movement of the material flow over the conveyor section. The bursts or their wave forms and wave patterns are evaluated. This requires the identification of meaningful features. This is used for the determination (extraction) of the AE features and the generation of an AE data set for each burst. The determination and evaluation may include the following AE features:
arrival time (absolute time of the first threshold crossing)
maximum amplitude
rise time (time interval between the first crossing of the threshold and the time of the maximum amplitude)
decay time
signal duration (time interval between first and last crossing of the threshold) and also
overshooting of a hit or count (number of times that the threshold is crossed in one polarity)
energy (integral of the squared or absolute instantaneous values of the voltage profile)
RMS (effective value) of the continuous background noise for the corresponding hit.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1-9. (canceled)

10. A method for analyzing a material flow, comprising:
guiding the material flow over a conveyor section;
wherein the conveyor section comprises a plurality of sound sensors, wherein the sound sensors are arranged on a contact element of the conveyor section or one of the contact elements integrated into the conveyor section;
detecting the acoustic signals generated by the material flow through the plurality of the sound sensors;
converting the acoustic signals into digital signals;
providing an evaluation unit;
comparing the digital signals using the evaluation unit to the reference values determined by individual recognition features of the material components;
comparatively assessing the digital signals;
identifying the material components; and,
determining a mass fraction of at least one material component in the material flow.

11. The method of claim 10, further comprising detecting the acoustic signals and evaluating in the form of acoustic emission and/or structure-borne sound and/or airborne sound and/or liquid-borne sound.

12. The method of claim 11, further comprising calculating and evaluation one or more of the following parameters:
Arithmetic mean
Median
Variance
Standard deviation
Effective value/RMS value (Root Mean Square)
Quadratic mean/RMQ value
RMX value
Crest factor
Bulge factor
Maximum value
Peak2RMS value
Peak2Peak value.

13. The method of claim 11, further comprising detecting and evaluating individual bursts.

14. An apparatus for analyzing a material flow, comprising:
at least one sound sensor;
a conveyor section for moving the material flow relative to the plurality of sound sensors;
wherein the conveyor section is part of a continuous conveyor or a continuous conveyor system;
a contact element, wherein the at least one sounds sensor is arranged on the contact element;
an evaluation unit, wherein the at least one sound sensor is linked to the evaluation unit, and wherein the evaluation unit includes an identification means for identifying the material components and the mass fraction of at least one material component in the material flow.

15. The apparatus of claim 14, wherein the at least one sound sensor is a sound emission sensor, a structure-borne sound sensor, an airborne sound sensor, or a liquid-borne sound sensor.

16. The apparatus of claim 14, wherein the at least one sound sensor comprises a plurality of sound sensors.

17. The method of claim 10, wherein the material comprises a plurality of material components.

18. The method of claim 10, wherein the conveyor section is part of a continuous conveyor or a continuous conveyor system.
